(19) United States
(12) Patent Application Publication
(10) Pub. No.: US 2022/0001527 A1
(43) Pub. Date: Jan. 6, 2022

(54) Two-handled Knife

(71) Applicant: Carmelo Phillip Giaimo, City Beach (AU)

(72) Inventor: Carmelo Phillip Giaimo, City Beach (AU)

(21) Appl. No.: 16/919,344

(22) Filed: Jul. 2, 2020

(51) Int. Cl. B25G 1/10; B26B 3/02; A21C 15/04

(52) U.S. Cl. CPC B25G 1/102; A21C 15/04; B26B 3/02

(57) ABSTRACT

A two-handled knife has an elongate blade extending from a base to a tip and having a lower edge and an upper edge. The two-handled knife further has a pair of handles each extending from the base of the blade to a grip portion, wherein the pair of handles are laterally spaced such that the grip portions are spaced a width apart. The width is large enough to accommodate a human hand around each grip portion.

### BACKGROUND OF THE INVENTION

### Field of the Invention

This invention relates generally to knives, and more particularly to a two-handled knife adapted to be gripped by two human hands.

### Description of Related Art

A knife typically includes a single handle that a user can grasp. The handle includes a hilt or base, from which extends an elongate blade shaped and adapted for cutting objects. In the field of weddings, it is common to sell knives in pairs, one for the groom and one for the bride, for ceremonial use in cutting a wedding cake. However, the prior art does not teach a knife having two handles spaced a width apart, each adapted to each by a human hand, which a bride and groom can use together, simultaneously, for cutting a wedding cake. The present invention fulfills these needs and provides further advantages as described in the following summary.

### SUMMARY OF THE INVENTION

The present invention teaches certain benefits in construction and use which give rise to the objectives described below.

The present invention provides a two-handled knife comprising an elongate blade extending from a base to a tip and having a lower edge and an upper edge. The two-handled knife further comprises a pair of handles each extending from the base of the blade to a grip portion, wherein the pair of handles are laterally spaced such that the grip portions are spaced a width apart. The width is large enough to accommodate a human hand around each grip portion.

A primary objective of the present invention is to provide a two-handled knife having advantages not taught by the prior art.

Another objective is to provide a two-handled knife adapted to be gripped by two human hands for simultaneously cutting a cake.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a two-handled knife according to one embodiment of the present invention;

FIG. 2 is a side elevational view thereof; and

FIG. 3 is a top plan view thereof.

### DETAILED DESCRIPTION OF THE INVENTION

The above-described drawing figures illustrate the invention, a two-handled knife 10 adapted to be simultaneously gripped by two persons for jointly making a cut, typically making a first cut into a cake.

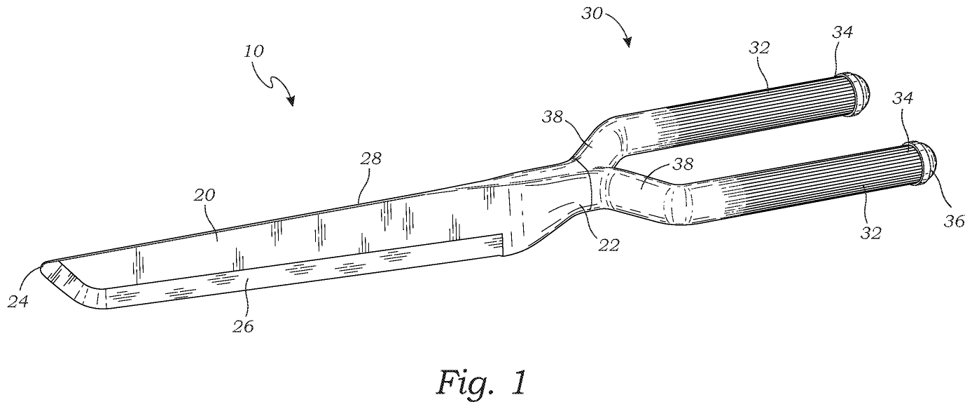

FIG. 1 is a perspective view of the two-handled knife 10 according to one embodiment of the present invention. As shown in FIG. 1, the two-handled knife 10 includes an elongate blade 20 extending from a base 22 to a tip 24. The blade 20 includes a lower edge 26 that is adapted for cutting, and an upper edge 28, which is typically blunt, but which may also be adapted for cutting. The lower edge 26 and/or upper edge 28 of the elongate blade 20 may be substantially straight, or may be irregular or curved. The elongate blade 20 may further include a variety of features commonly found on various cutting knives, e.g., portions which are beveled, serrated, pronged, etc., or any other features devisable by one skilled in the art. In some embodiments, the elongate blade 20 is a wide tapering or wedge blade 20 commonly used for cutting a cake, but may be any type of blade 20 commonly used for cutting food material, e.g., a table knife, dessert knife, carving knife, etc.

In this embodiment, the base 22 of the two-handled knife 10 is an elongate extension of the blade 20, but in other embodiments, the base 22 may be other shapes, or similar to other commonly found base structures, e.g., having a discoid base, heel, cross-guard, etc.

A pair of handles 30 extend from the base 22, each handle extending to a grip portion 32. The handles 30 may be shaped, configured, and attached to the blade 20 in a variety of ways, with one embodiment discussed in greater detail below.

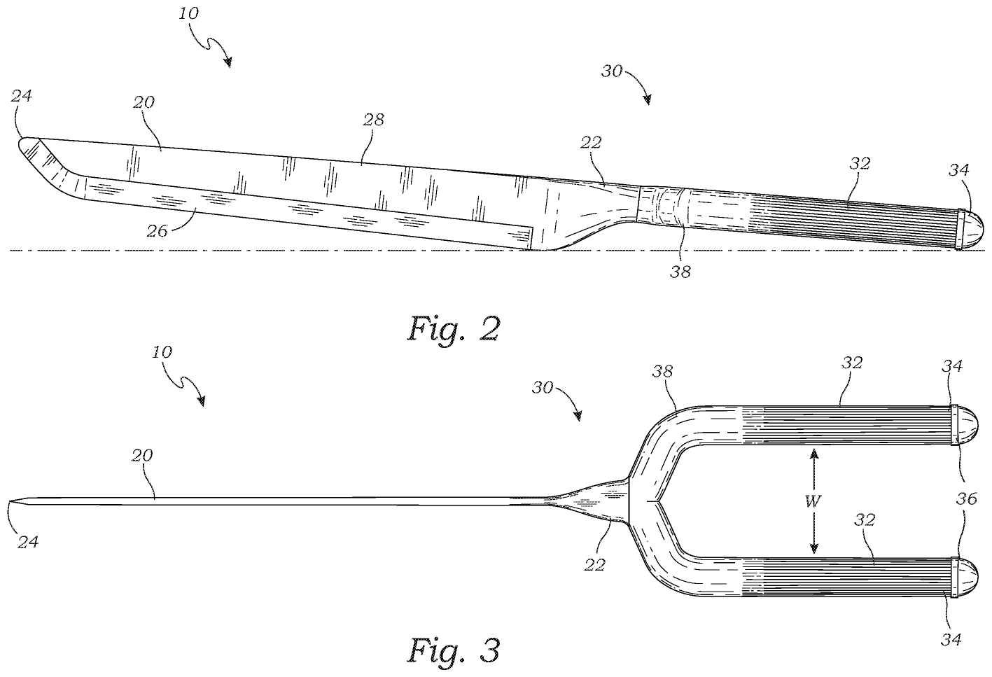

FIG. 2 is a side elevational view of the two-handled knife 10, and FIG. 3 is a top plan view thereof. As shown in FIGS. 1-3, each of the pair of handles 30 includes a proximate portion 38 adjacent the base 22, and a distal portion 32 extending from the proximate portion 38. In this embodiment, the proximate portions 38 are curved to increase in lateral distance from each other as they move further from the base 22, and wherein the distal portions 32 are generally parallel to each other and spaced a width W apart from each other. The distal portion 32 are elongate in shape, and are shaped and otherwise adapted to form grip portions that are adapted to be gripped by a human hand.

As shown in FIGS. 2 and 3, in this embodiment, the two-handled knife 10 may be set upon a generally planar surface wherein the base 22 and terminal ends 34 of the pair of handles 30 are in contact with the surface, and the rest of the pair of handles 30 and the elongate blade 20 are elevated from the surface.

In some embodiments, the pair of handles 30 are integrally formed with the grip portions 32, but in other embodiments, the grip portions 32 may be removably attached. In this embodiment, the grip portions 32 may be textured. In some embodiments, the grip portions 32 are of a different material than the rest of the pair of handles 30 e.g., being made of lacquered material, rubber, plastic, metal, etc., or they may be constructed of the same material. The grip portions 32 and/or pair of handles 30 may further include axially extending stoppers 36 on terminal ends 34 of the pair of handles 30. Other features may be included within the grip portions 32, such as decorative detailing, or any other feature which may be devised by one skilled in the art.

As shown in FIG. 3, the grip portions 32 are laterally spaced the width W apart, enough to accommodate a human hand around each grip portion. In some embodiments, the width W may be between 2.5-6 inches. Various alternative configurations may be devised by those skilled in the art, and such alternatives should be considered within the scope of the present invention.

In use, the two people may use the two-handled knife 10 simultaneously, each holding one of the grip portions 32. This is particularly adapted for ceremonial purposes, such as cutting a wedding cake; however, alternative uses may be devised for this knife 10, and such alternatives should be considered within the scope of the present invention. Further, while one embodiment is disclosed herein, other embodiments may also be devised according to the teachings of the present invention, which is considered within the scope of the present invention.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A two-handled knife comprising:
an elongate blade extending from a base to a tip and having a lower edge and an upper edge;
a pair of handles, each extending from the base of the blade to a grip portion; and
wherein the pair of handles are laterally spaced such that the grip portions are spaced a width apart, the width being large enough to accommodate a human hand around each of the grip portions.

2. The two-handled knife of claim 1, wherein the width is between 2.5-6 inches.

3. The two-handled knife of claim 1, wherein the base is generally discoid in shape.

4. The two-handled knife of claim 1, wherein each of the pair of handles includes a proximate portion adjacent the base, and a distal portion extending from the proximate portion, wherein the proximate portions are curved to increase in lateral distance from each other as they move further from the base, and wherein the distal portions are generally parallel to each other and spaced a width apart from each other.

5. A two-handled knife comprising:
an elongate blade extending from a base to a tip and having a lower edge and an upper edge;
a pair of handles, each extending from the base of the blade to a grip portion;
wherein the pair of handles are laterally spaced such that the grip portions are spaced a width apart, the width being large enough to accommodate a human hand around each of the grip portions; and
wherein the width is between 2.5-6 inches.
